(19) United States
(12) Patent Application Publication
(10) Pub. No.: US 2024/0420652 A1
(43) Pub. Date: Dec. 19, 2024

(54) DISPLAY MODE SWITCHING METHOD AND APPARATUS, DEVICE, AND STORAGE MEDIUM

(71) Applicant: Beijing Zitiao Network Technology Co., Ltd., Beijing (CN)

(72) Inventors: Jiexin YUAN, Beijing (CN); Xuesha YANG, Beijing (CN)

(21) Appl. No.: 18/741,922

(22) Filed: Jun. 13, 2024

(30) Foreign Application Priority Data
Jun. 15, 2023 (CN) 202310710994.5

(51) Int. Cl. G09G 3/34; G09G 5/10

(52) U.S. Cl. CPC G09G 3/3406; G09G 5/10; G09G 2300/0426; G09G 2320/0626

(57) ABSTRACT

Embodiments of the present disclosure provide a display mode switching method and apparatus, a device and a storage medium. After a highlighting operation triggered by a user for a first object is acquired, a first object cluster may be determined according to the first object. The first object cluster includes the first object, and the first object cluster corresponds to a first flow logic in a first flowchart. After the first object cluster is determined, a display mode of the first object cluster may be switched. That is, if the user wants to view an object corresponding to a certain flow logic in the flowchart, the user may trigger a highlighting operation for a certain object (e.g., the first object) among all the objects corresponding to the flow logic, thereby triggering a display mode of the object corresponding to the flow logic.

### CROSS-REFERENCE TO RELATED APPLICATION

The present application claims the priority to Chinese Patent Application No. 202310710994.5, filed on Jun. 15, 2023, the entire disclosure of which is incorporated herein by reference as portion of the present application.

### TECHNICAL FIELD

The present disclosure relates to a display mode switching method and apparatus, a device, and a storage medium.

### BACKGROUND

Flowcharts may visually present processing logics and have been applied in many fields. A flowchart may include nodes and connection lines. The nodes are used for indicating relevant actions or other information in the flow, and the connection lines are used for indicating the execution order of the nodes in the flow. In this way, the user may understand the processing logic and specific details of the flow by viewing the structure of the flowchart.

For example, in an application edition scenario, the user may develop an application service on an application Platform as a Service (aPaaS) platform. The aPaaS platform has a feature of less code or zero code, and the user may create an application on the aPaaS platform by “dragging, pulling and dropping” elements and modules provided by the platform, to implement low-threshold and fast application creation. During the process of generating an application by using the aPaaS platform, the user may firstly build a flowchart related to the produced application, to refer to the flowchart for subsequent application production.

In practical application scenarios, the structure of the flowchart may be complex and inconvenient for the user to view.

### SUMMARY

In order to solve the above-mentioned problems, the present disclosure provides a display mode switching method and apparatus, a device, and a storage medium.

Based on this, the technical solutions provided by the present disclosure are as follows:

In a first aspect, the present disclosure provides a display mode switching method, and the method includes:
acquiring a highlighting operation triggered by a user for a first object, in which the first object belongs to a first flowchart;
determining a first object cluster according to the first object, in which the first object cluster includes the first object, and the first object cluster corresponds to a first flow logic in the first flowchart; and
switching a display mode of the first object cluster.

In some optional embodiments, the determining the first object cluster according to the first object includes:
in response to the first object being a parent node of a first branch path, determining the first flow logic as a flow logic corresponding to the first branch path; and
determining nodes and connection lines included in the first branch path as objects in the first object cluster.

In some optional embodiments, the determining nodes and connection lines comprised in the first branch path as objects in the first object cluster includes:
determining a tail node of the first branch path according to the first flow logic; and
determining nodes and connection lines between the first object and the tail node as objects in the first object cluster.

In some optional embodiments, the determining the first object cluster according to the first object includes:
in response to the first object belonging to a sub-path of a second branch path, determining the first flow logic as a flow logic corresponding to the sub-path; and
determining nodes and connection lines included in the sub-path as objects in the first object cluster.

In some optional embodiments, the determining the first object cluster according to the first object includes:

in response to the first object belonging to a loop path, determining the first flow logic as a flow logic corresponding to the loop path; and

determining nodes and connection lines included in the loop path as objects in the first object cluster.

In some optional embodiments, the switching the display mode of the first object cluster includes:
switching a display brightness of the first object cluster from a first brightness to a second brightness, in which the second brightness is greater than the first brightness.

In some optional embodiments, the first object is a node or a connection line in the first flowchart.

In a second aspect, the present disclosure provides a display mode switching apparatus, and the apparatus includes:
an acquisition unit, configured to acquire a highlighting operation triggered by a user for a first object, in which the first object belongs to a first flowchart;
a determination unit, configured to determine a first object cluster according to the first object, in which the first object cluster includes the first object, and the first object cluster corresponds to a first flow logic in the first flowchart; and
a display unit, configured to switch a display mode of the first object cluster.

In some optional embodiments, the determination unit is specifically configured to: in response to the first object being a parent node of a first branch path, determine the first flow logic as a flow logic corresponding to the first branch path; and determine nodes and connection lines included in the first branch path as objects in the first object cluster.

In some optional embodiments, the determination unit is specifically configured to: determine a tail node of the first branch path according to the first flow logic; and determine nodes and connection lines between the first object and the tail node as objects in the first object cluster.

In some optional embodiments, the determination unit is specifically configured to: in response to the first object belonging to a sub-path of a second branch path, determine the first flow logic as a flow logic corresponding to the sub-path; and determine nodes and connection lines included in the sub-path as objects in the first object cluster.

In some optional embodiments, the determination unit is specifically configured to: in response to the first object belonging to a loop path, determine the first flow logic as a flow logic corresponding to the loop path; and determine nodes and connection lines included in the loop path as objects in the first object cluster.

In some optional embodiments, the display unit is specifically configured to switch a display brightness of the first object cluster from a first brightness to a second brightness, and the second brightness is greater than the first brightness.

In some optional embodiments, the first object is a node or a connection line in the first flowchart.

In a third aspect, the present disclosure provides an electronic device, and the electronic device includes:
one or more processors; and
a storage apparatus, storing one or more programs;
the one or more programs, when executed by the one or more processors, cause the one or more processors to implement the method according to any one of the embodiments in the first aspect.

In a fourth aspect, the present disclosure provides a computer-readable medium, storing a computer program, and the computer program, when executed by a processor, implements the method according to any one of the embodiments in the first aspect.

In a fifth aspect, the present disclosure provides a computer program product, and the computer program, when run on a device, causes the device to perform the method according to any one of the embodiments in the first aspect.

The embodiments of the present disclosure provide a display mode switching method and apparatus, a device and a storage medium. If a user wants to view some objects in a first flowchart, the user may trigger a highlighting operation for a first object in the flowchart. After acquiring the highlighting operation triggered by the user for the first object, a first object cluster may be determined according to the first object. The first object cluster includes at least one node and a plurality of connection lines. The first object cluster includes the first object, and other objects included in the first object cluster are associated with the first object. The objects in the first object cluster together constitute a first flow logic in the first flowchart. After the first object cluster is determined, the display mode of the first object cluster may be switched. That is, if the user wants to view an object corresponding to a certain flow logic in the flowchart, the user may trigger a highlighting operation for a certain object (e.g., the first object) among all the objects corresponding to the flow logic, thereby triggering a display mode of the object corresponding to the flow logic. In this way, the object corresponding to the flow logic is displayed in a way different from that of other objects in the first flowchart, and the user may easily distinguish between the object corresponding to the flow logic and other objects in the first flowchart. In this way, the user may trigger highlighting of some objects in the flowchart through an operation for better viewing.

### BRIEF DESCRIPTION OF DRAWINGS

In order to more clearly illustrate the technical solutions in the embodiments of the present disclosure, the drawings to be used in the description of the embodiments will be briefly described below. Obviously, the drawings in the following description are only some embodiments recorded in the present disclosure. For those ordinarily skilled in the art, other drawings may be obtained based on these drawings without inventive work.

FIG. 1 is a flowchart of a display mode switching method provided by the embodiments of the present disclosure;

FIG. 2A is a schematic diagram of an exemplary application scenario provided by the embodiments of the present disclosure;

FIG. 2B is a schematic diagram of another exemplary application scenario provided by the embodiments of the present disclosure;

FIG. 3A is a schematic diagram of another exemplary application scenario provided by the embodiments of the present disclosure;

FIG. 3B is a schematic diagram of another exemplary application scenario provided by the embodiments of the present disclosure;

FIG. 3C is a schematic diagram of another exemplary application scenario provided by the embodiments of the present disclosure;

FIG. 4 is a schematic structural diagram of a display mode switching apparatus provided by the embodiments of the present disclosure; and

FIG. 5 is a schematic diagram of a basic structure of an electronic device provided by the embodiments of the present disclosure.

### DETAILED DESCRIPTION

Embodiments of the present disclosure will be described in more detail below with reference to the drawings. While certain embodiments of the present disclosure are shown in the drawings, it should be understood that the present disclosure may be embodied in various forms and should not be construed as limited to the embodiments set forth herein. Rather, these embodiments are provided for a thorough and complete understanding of the present disclosure. It should be understood that the drawings and embodiments of the present disclosure are only for exemplary purposes and are not intended to limit the protection scope of the present disclosure.

It should be understood that the various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

It should be noted that concepts such as the “first,” “second,” or the like mentioned in the present disclosure are only used to distinguish different devices, modules or units, and are not used to limit the interdependence relationship or the order of functions performed by these devices, modules or units.

It should be noted that the modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

A flowchart includes nodes and connection lines used for connecting the nodes. The nodes and the connection lines may be referred to as flowchart objects, that is, objects in the flowchart. A node may be used for indicating a specific action in the flowchart, and a connection line may be used for indicating an execution order of actions in the flowchart. In this way, a processing logic corresponding to the flowchart may be visually presented to the user through nodes and connection lines, to facilitate the user to view. In the embodiment of the present disclosure, the processing logic corresponding to the flowchart may be referred to as a flow logic. Specifically, a processing logic corresponding to one flowchart may be referred to as a flow logic. The processing logic expressed by some nodes and connection lines in the flowchart may also be referred to as a flow logic.

The user may edit a flow related to production of an application on the aPaaS platform. For example, the user may edit a flow of processing data by an application, for reference in a subsequent production process of the application on the aPaaS platform. The flow is usually presented in a form of flowchart. The user may edit the required flowchart on a flow edit page provided by the aPaaS platform. Specifically, the user may create nodes on the aPaaS platform and set connection lines between nodes, to create a corresponding flow logic.

However, if the flowchart is complex, it may be difficult for the user to understand the flow logic through the flowchart. For example, if there are more actions in the logic presented in the flowchart, there may be more nodes in the flowchart, and these nodes may affect the user's viewing; or if the execution order of actions in the flowchart is complex, there may be more connection lines in the flowchart, making it difficult for the user to distinguish between different connection lines; or if the processing logic presented by the flowchart is complex and involves a large number of flow logics, and there may be nested relationships or branch relationships between different flow logics, it may also not be favorable for the user to distinguish a specific processing logic in the flowchart.

For example, in some optional embodiments, the flow logic may include a loop processing logic and a branch processing logic.

The loop processing logic is used for indicating repeated execution of one or more actions until a condition for exiting the loop processing logic is met. A group of objects used for embodying the loop processing logic in the flowchart may be referred to as a loop path. The loop path includes at least one node and a plurality of connection lines. The last node in the loop path corresponds to two paths: one path corresponds to a node outside the loop path, and the other path corresponds to the first node in the loop path.

In some optional embodiments, the distance between the first node and the last node in the loop may be too far, so that the user has to follow the connection lines to return to the first node in the loop after viewing the last node in the loop. In the process, the user has to search for the first node in the loop from a plurality of nodes, which, thus, not only reduces efficiency of the user in viewing the flowchart, but also probably leads to a wrong node.

The branch processing logic is used for indicating selective execution of a plurality of actions, or used for indicating parallel execution of a plurality of actions. A group of objects used for embodying the branch processing logic in the flowchart may be referred to as a branch path. The branch path includes a parent node, a tail node, and a plurality of sub-paths. Each sub-path includes at least one child node. The parent node of the branch path is respectively connected with the first node in each sub-path through a connection line, indicating that it may enter different sub-paths after entering the branch processing logic. The last node of each sub-path is connected with the tail node, indicating that the branch processing logic will end after each sub-path ends and it will enter other subsequent processing procedure. Optionally, each sub-path of the branch path may correspond to one branch in the branch processing logic.

If the branch path includes a large number of sub-paths, then the plurality of sub-paths may affect the user's viewing, making it difficult for the user to find a specific sub-path from the plurality of sub-paths. Or if a sub-path of a branch path includes a plurality of nodes, the user may have to drag the flowchart extensively when switching from the sub-path to view other sub-paths, so that the user may fail to distinguish the sub-paths.

Moreover, in practical application scenarios, the loop path may nest branch paths or other loop paths, and each sub-path in the branch path may further nest other branch paths or loop paths. In this way, the user has to distinguish different paths from a complex flowchart, so as to analyze a single path. When distinguishing the paths, the user further has to analyze actions indicated by each node and logical relationships between nodes one by one. Obviously, such procedure will consume much energy of the user.

In order to solve the above-mentioned problems, the embodiments of the present disclosure provide a display mode switching method, which will be introduced in detail in conjunction with the drawings of the specification.

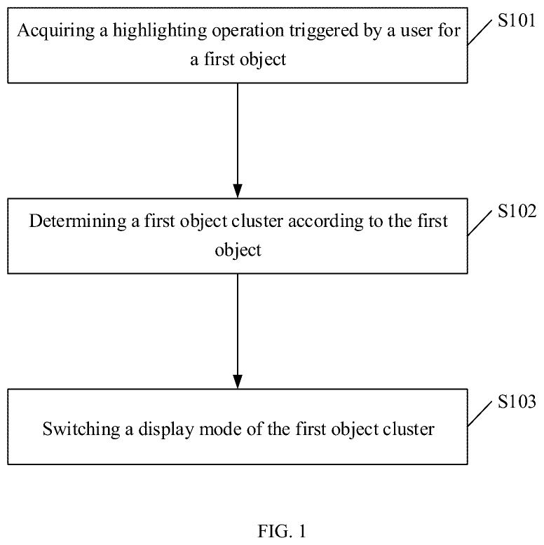

Referring to FIG. 1, FIG. 1 is an information interaction diagram of a display mode switching method provided by the embodiments of the present disclosure, and the embodiments of the present disclosure may be applicable to an application scenario of editing or viewing a flowchart. The display mode switching method may be executed by a display mode switching apparatus, and the apparatus may be implemented by software and integrated into a client of a user. The client may be a software client or a webpage client of aPaaS. If the client is a software client of aPaaS, the client may be integrated into a personal computer (PC) or a mobile terminal. In some optional embodiments, the client may be a module having a flowchart edit function, for example, an aPaaS module, in other software. The above-mentioned other software may be software having an instant communication function, for example, office software. That is, the above-mentioned client may be an aPaaS module in instant communication software.

As shown in FIG. 1, the method specifically includes the following steps.

S101: acquiring a highlighting operation triggered by a user for a first object.

According to the foregoing introduction, it may be known that if the logic presented by the flowchart is more complex, a corresponding structure of the flowchart will also be more complex, making it inconvenient for the user to view. Specifically, if the flowchart further includes logically complex paths such as loop paths or branch paths, the user may find it difficult to separate relatively independent paths from the entire flowchart for viewing.

Therefore, in the embodiments of the present disclosure, if the user wants to view some objects in the flowchart firstly, the user may trigger a highlighting operation for a certain object in the flowchart. The flowchart viewed by the user may be referred to as a first flowchart, and the flowchart object for which the user triggers the highlighting operation may be referred to as a first object. Specifically, the user may trigger the highlighting operation by clicking on a display region corresponding to the first object, or may also trigger the highlighting operation by moving a position of a cursor control (e.g., a mouse pointer control) to the display region corresponding to the first object. The above-mentioned operation of moving the position of the cursor control to the display region corresponding to the first object may be referred to as a hover operation.

In the embodiments of the present disclosure, the first object may be a node in the flowchart or a connection line in the flowchart. Text below may be referred to for detailed introduction of the first object, and no details will be repeated here.

It should be noted that the term “user” here refers to an object triggering the highlighting operation. The user may refer to specific personnel or an account logged into software to which the display mode switching apparatus belongs. Optionally, if the user refers to the account logged into the software, different operations according to the corresponding embodiment of FIG. 1 may be triggered by different personnel.

S102: determining a first object cluster according to the first object.

After acquiring the highlighting operation triggered by the user, the first object cluster may be determined according to the first object. The first object cluster includes a plurality of objects, and the flowchart objects included in the first object cluster include the foregoing first object. The flowchart objects included in the first object cluster are those some objects the user wants to view in the flowchart. Specifically, the first object cluster corresponds to the first flow logic in the first flowchart. That is, the objects in the first object cluster are used for presenting the first flow logic in the first flowchart.

That is, if the user wants to highlight a flowchart object corresponding to a certain flow logic in the flowchart, the user may trigger a highlighting operation for a certain object among all the objects corresponding to the flow logic in the flowchart. Optionally, the user may trigger a highlighting operation through any object in the flow logic, or may also trigger a highlighting operation through a specific flowchart object in the flow logic. That is, the first object may be a specific flowchart object in the first object cluster, or may also be any object in the first object cluster.

In practical application scenarios, there is usually certain correlation between those some objects the user wants to highlight. Correspondingly, when determining the first object cluster according to the first object, a cluster associated with the first object, that is, the first object cluster, may be determined according to a correlation between the flowchart objects.

In some optional embodiments, other objects connected with the first object may be determined as flowchart objects in the first object cluster. Specifically, if the first object is a node, then when determining the first object cluster, other nodes directly connected with the first object, as well as connection lines used for connecting the first object and the above-mentioned nodes, may be determined as the flowchart objects in the first object cluster. Or if the first object is a connection line, then all nodes connected by the first object may be determined as the flowchart objects in the first object cluster.

In some other optional embodiments, the flowchart objects in the first object cluster may be determined according to a distance between a flowchart object and the first object. The distance between the flowchart object and the first object may include, for example, the length of a connection line between the flowchart object and the first object, or the number of nodes between the flowchart object and the first object. A node between the flowchart object and the first object refers to a node on a path connecting between the flowchart object and the first object. Specifically, a flowchart object whose distance from the first object is less than a preset threshold in the flowchart may be determined as a flowchart object in the first object cluster.

In some other optional embodiments, the flowchart objects in the first object cluster may be determined according to a correlation thereof with the first object. Specifically, if the first object is a node, a correlation coefficient between each node in the flowchart and the first object may be calculated separately, and nodes whose correlation coefficients with the first object are greater than a preset threshold and connection lines used for connecting these nodes may be determined as the flowchart objects in the first object cluster.

In some other optional embodiments, the flowchart objects in the first object cluster may be determined according to the flow logic corresponding to the first object. That is, according to the correlation between the flowchart objects, a first flow logic corresponding to the first object may be determined firstly, and then the flowchart objects corresponding to the first flow logic may be determined as objects in the first object cluster. Hereinafter, detailed introduction is given.

In practical application scenarios, complexity of the flow logic presented by the flowchart is usually a main reason that affects the user to view the flowchart. Nodes and connection lines corresponding to different flow logics are concentrated together, making it inconvenient for the user to view. Specifically, if there is intersection or nesting between different flow logics, it is difficult for the user to individually view a certain flow logic therein.

Therefore, after acquiring the highlighting operation triggered by the user, it may be judged whether the first object corresponds to a certain flow logic. If the first object corresponds to a certain flow logic, all flowchart objects used for representing the flow logic in the flowchart may be determined as the flowchart objects in the first object cluster. That is, if a user wants to view a specific flow logic in the flowchart, the user may find an object corresponding to the flow logic (i.e. the foregoing first object), and then trigger a highlighting operation for the object. In this way, the flowchart objects used for identifying the flow logic in the flowchart will all be highlighted for the user to view.

According to the foregoing introduction, it may be known that the common flow logic in the flowchart may include a branch processing logic and a loop processing logic. Hereinafter, an implementation for determining the objects in the first object cluster will be introduced by taking some practical flow logics as an example.

Implementation 1: the first object belongs to a loop path.

In the first possible implementation, the first object is a flowchart object in a loop path. That is, the flow logic corresponding to the first object is a loop processing logic. Optionally, the first object may be either a node in the loop path or a connection line between nodes in the loop path.

Correspondingly, if the user triggers a highlighting operation for the first object, then each flowchart object in the loop path to which the first object belongs may be determined as a flowchart object in the first object cluster.

Specifically, a flowchart object in the first object cluster may be determined according to an identifier of the flowchart object. For example, when drawing a flowchart, the user may create a loop path by adding a preset loop path template. The loop path template is used for presenting a basic structure of the loop path, and the user may perform operations such as adding nodes and setting node attributes on the loop path template. That is, the user may add a loop path template to the flowchart through a dragging operation or an adding operation. Next, the user may adjust the nodes added in the loop path template and set the attributes of the nodes in the loop path template, to complete creation of the loop path.

Because the nodes and the connection lines in the loop path are obtained based on the loop path template, rules may be set such that the nodes and the connection lines corresponding to the loop path template include an identifier of the loop path. That is, the nodes and the connection lines in the loop path template, as well as attributes of each node and each connection line added by the user in the loop path template, may all include the identifier of the loop path. Correspondingly, after acquiring the highlighting operation triggered by the user for the first object, the identifier of the loop path may be determined according to the first object, and other flowchart objects including the identifier of the loop path in the flowchart may be determined as the first object cluster. Optionally, the above-mentioned identifier of the loop path may be carried in attribute information of the flowchart object.

Or the loop path to which the first object belongs may be determined by analyzing the flowchart. Specifically, after acquiring the highlighting operation triggered by the user for the first object, the flowchart may be analyzed to determine the loop path to which the first object belongs, to determine the first object cluster.

According to the foregoing introduction, it may be known that the branch path includes a plurality of sub-paths. Correspondingly, when viewing the flowchart, the user may want to view the entire branch path, or may want to view a sub-path within the branch path. In order to distinguish different user needs, different flowchart objects in the loop path may be set to correspond to different first object clusters. Implementation 2 or Implementation 3 below is one of such implementations.

Implementation 2: the first object is a parent node or a tail node of the branch path.

In order to meet the need of the user to view the branch path, a function of triggering a highlighting operation may be set for the parent node or the tail node of the branch path. In this way, if the user wants to view the entire loop path, the user may trigger the highlighting operation for the parent node or the tail node of the loop path. That is, if the first object is the parent node or the tail node of the loop path, then the first object cluster may include each node in the loop path and connection lines between the nodes. Correspondingly, the flow logic corresponding to the first object includes a branch processing logic.

Similar to the foregoing Implementation 1, the flowchart objects in the first object cluster may be determined according to the identifier of the flowchart objects. Correspondingly, when creating a loop path, a loop path template may be firstly created in the flowchart. The loop path template includes a parent node and a tail node, as well as a plurality of sub-path templates between the parent node and the tail node. The user may edit each sub-path template, or may also add a new sub-path between the parent node and the tail node.

When creating a loop path, each flowchart object in the loop path may carry an identifier of the loop path. Optionally, the identifier of the loop path may be carried in attribute information of the flowchart object. Correspondingly, after acquiring the highlighting operation triggered by the user for the first object, the identifier of the loop path may be acquired from the attribute information of the first object, and the flowchart object whose attribute information includes the identifier of the loop path may be determined as the flowchart object in the first object cluster according to the identifier of the loop path.

Or in some other optional implementations, the flowchart path in the first object cluster may be determined according to the parent node and the tail node. Specifically, after acquiring the highlighting operation triggered by the user for the parent node (or the tail node) of the branch path, the tail node (or the parent node) of the branch path may be determined firstly. Then a plurality of sub-paths from the parent node to the tail node are determined, and then all nodes and connection lines on the sub-paths are determined as the flowchart objects in the first object cluster.

In some possible application scenarios, the branch flow logic may include a logic for end processing. That is, under the branch flow logic, if a certain condition is met, it may directly jump to a final end step. As embodied in the flowchart, the corresponding branch path may include an end sub-path. The first node of the end sub-path is connected with the parent node of the branch path, and the last node of the end path corresponds to an end of actions as represented by the flowchart.

Correspondingly, if the first object cluster is determined based on the parent node and the tail node, then even if the end sub-path is not connected with the tail node through a connection line, the node and the connection line corresponding to the end sub-path also belong to the first object cluster because the first node of the end sub-path is connected with the parent node of the branch path.

Implementation 3: the first object belongs to a sub-path of the branch path.

In practical application scenarios, there is not only a need for the user to view the entire branch processing logic, but also a need for the user to view a specific branch in the branch processing logic. If the user needs to view a specific branch in the branch processing logic, the user may trigger a highlighting operation for a sub-path of the branch path. That is, the above-mentioned first object may belong to the sub-path of the branch path.

To meet the user's need to view a certain sub-path in the branch path, a function of triggering a highlighting operation may be set for the flowchart object on the sub-path in the branch path. In this way, if a highlighting operation triggered by the user for a flowchart object on a certain sub-path is acquired, the nodes and the connection lines on the sub-path may be determined as flowchart objects in the first object cluster. Optionally, the parent node and the child node of the branch path may also belong to the first object cluster.

That is, if the first object is a node or a connection line on a certain sub-path of a branch path, the nodes and the connection lines included in the sub-path may be determined as flowchart objects in the first object cluster.

It may be understood that the nodes or the connection lines on the sub-path may also be used for triggering highlight of the entire branch path. That is, in some other optional implementations, if the user triggers a highlighting operation for the first object on the sub-path of the branch path, the branch path to which the first object belongs may also be determined as the first object cluster.

Some implementations of determining the first object cluster according to the first object based on the flow logic are introduced above. In practical application scenarios, other modes may also be adopted to determine the first object cluster based on the first object, and no details will be repeated here.

It should be noted that in the embodiments of the present disclosure, the first object is a flowchart object having a function of triggering a highlighting operation in the flowchart. Because the first object is capable of triggering the highlighting operation, the first object cluster may be determined according to the first object. A flowchart object having no function of triggering a highlighting operation in the flowchart can neither be taken as the first object, nor determine the corresponding first object cluster.

S103: switching a display mode of the first object cluster.

After the first object cluster is determined, the display mode of the first object cluster may be switched. In this way, the display mode of the first object cluster is different from a display mode of another flowchart object in the first flowchart. The user viewing the first flowchart may distinguish between the objects in the first object cluster and objects in non-first object cluster according to the display mode.

Optionally, in some optional embodiments, the first object cluster may be highlighted according to a preset display mode, so that the user may distinguish between the flowchart objects in the first object cluster and other flowchart objects in the flowchart. Optionally, the above-mentioned preset display mode may include, for example, bold display, highlight display, colored display, and flashing display, etc. In this way, because the flowchart objects in the first object cluster are highlighted, the user may clearly distinguish the flowchart objects in the first object cluster from other flowchart objects in the flowchart, which facilitate the user to view.

The embodiments of the present disclosure provide a display mode switching method and apparatus, a device, and a storage medium. If a user wants to view some objects in a first flowchart, the user may trigger a highlighting operation for a first object in the flowchart. After acquiring the highlighting operation triggered by the user for the first object, a first object cluster may be determined according to the first object. The first object cluster includes at least one node and a plurality of connection lines. The first object cluster includes the first object, and other objects included in the first object cluster are associated with the first object. The objects in the first object cluster together constitute a first flow logic in the first flowchart. After the first object cluster is determined, the display mode of the first object cluster may be switched. That is, if the user wants to view an object corresponding to a certain flow logic in the flowchart, the user may trigger a highlighting operation for a certain object (e.g., the first object) among all the objects corresponding to the flow logic, thereby triggering a display mode of the object corresponding to the flow logic. In this way, the object corresponding to the flow logic is displayed in a way different from that of other objects in the first flowchart, and the user may easily distinguish between the object corresponding to the flow logic and other objects in the first flowchart. In this way, the user may trigger highlighting of some objects in the flowchart through an operation for better viewing.

Hereinafter, the display mode switching method provided by the embodiments of the present disclosure will be illustrated in conjunction with some practical application scenarios.

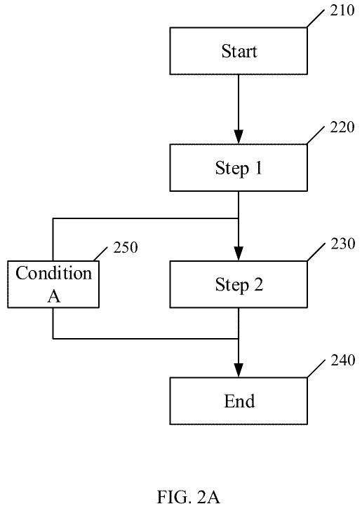

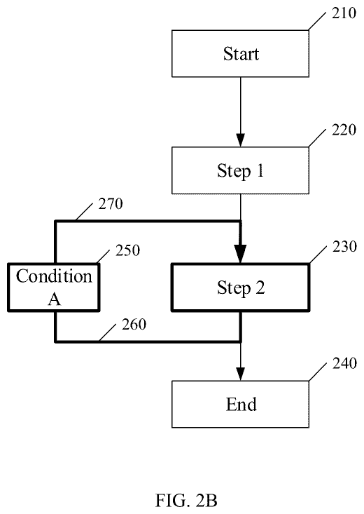

For example, during the process of the user viewing or configuring a flowchart on the aPaaS platform through a terminal device (e.g., a device such as a computer or a mobile phone), the terminal device may display an interface as shown in FIG. 2A. The interface may be the interface displayed on the aPaaS platform. In the interface shown in FIG. 2A, a flowchart 20 is displayed.

Specifically, the flowchart 20 includes a start node 210, a step node 220, a step node 230, an end node 240, and a condition node 250. Moreover, the flowchart 20 further includes a connection line pointing from the start node 210 to the step node 220, a connection line pointing from the step node 220 to the step node 230, a connection line pointing from the step node 230 to the end node 240, and a connection line pointing from the tail of the step node 230, passing through the condition node 250 and then to the head of step node 230. The step node 230 corresponds to Step 2, and the condition node 250 corresponds to Condition A.

The step node 230, the condition node 250, and the corresponding connection lines form a loop path. A flow logic corresponding to the loop path is: executing Step 2 and judging whether Condition A is met; if Condition A is met, end the processing; and if Condition A is not met, return to Step 2.

If the user wants to view the above-mentioned loop path, the user may trigger a highlighting operation for the step node 230 or the condition node 250, or may also trigger a highlighting operation for a connection line in the loop path. For example, if the user is viewing the flowchart 20 on a personal computer, the user may move a mouse pointer control to the position of the step node 230 to trigger a highlighting operation.

After the highlighting operation triggered by the user is acquired, the corresponding first object cluster may be determined and highlighted. Specifically, the flowchart as shown in FIG. 2B may be displayed. In the implementation shown in FIG. 2B, the step node 230, the condition node 250, the connection line 260 used for pointing from the step node 230 to the condition node 250 in the loop path, and the connection line 270 used for pointing from the condition node 250 to the step node 230 in the loop path are all displayed in bold for the user to distinguish.

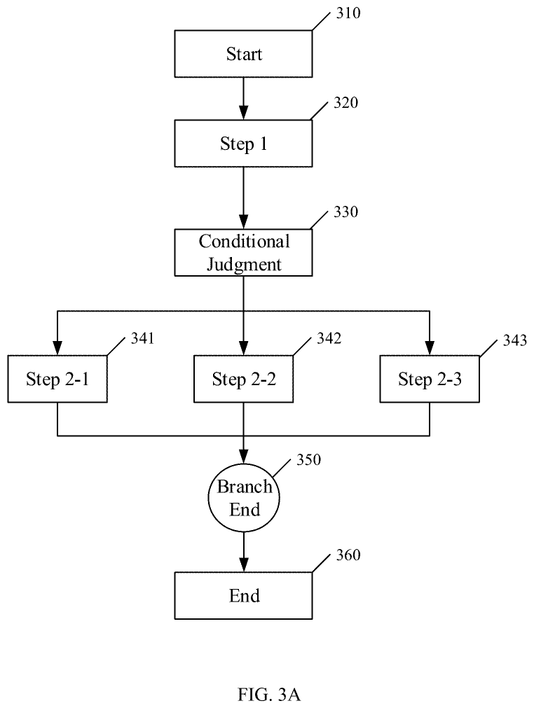

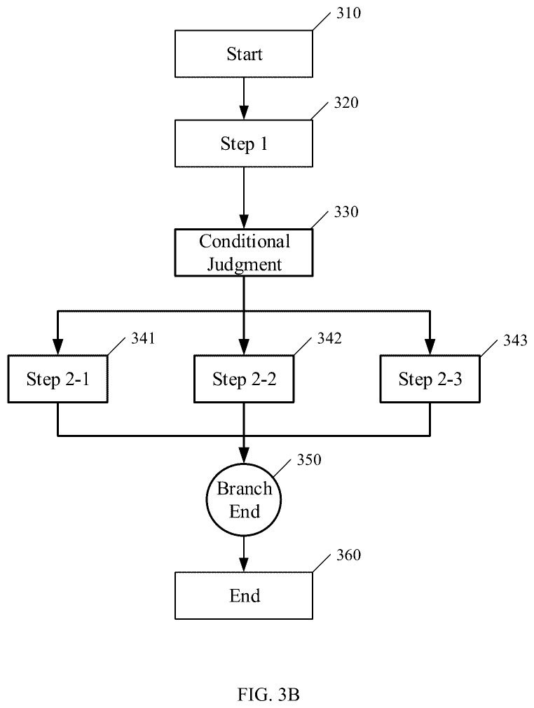

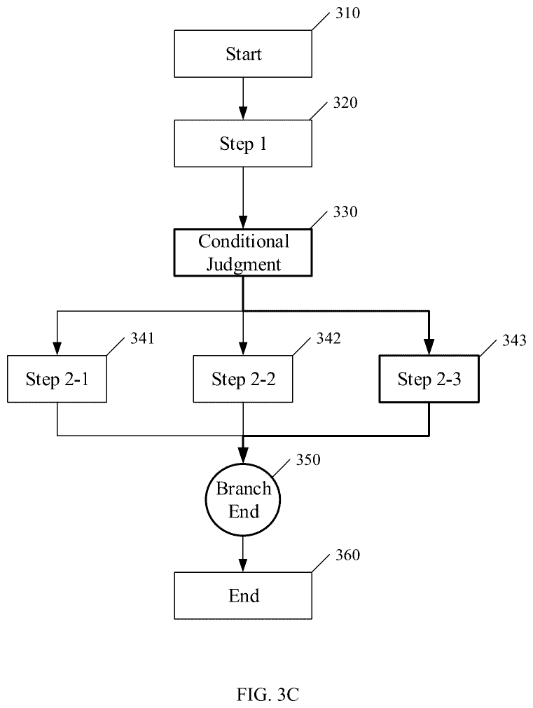

For another example, during the process of the user viewing or configuring the flowchart through a terminal device (e.g., a device such as a computer or a mobile phone), the terminal device may display the interface as shown in FIG. 3A. In the interface shown in FIG. 3A, a flowchart 30 is displayed.

Specifically, the flowchart 30 includes a start node 310, a step node 320, a parent node 330, a branch node 341, a branch node 342, a branch node 343, a tail node 350, and an end node 360. Moreover, the flowchart 30 further includes a connection line pointing from the start node 310 to the step node 320, a connection line pointing from the step node 320 to the parent node 330, three connection lines pointing from the parent node 330 respectively to the branch node 341, the branch node 342, and the branch node 343, three connection lines pointing respectively from the branch node 341, the branch node 342, and the branch node 343 to the tail node 350, and a connection line pointing from the tail node 350 to the end node 360. The branch node 341 corresponds to Step 2-1, the branch node 342 corresponds to Step 2-2, and the branch node 343 corresponds to Step 2-3.

The parent node 330, the branch node 341, the branch node 342, the branch node 343, and the tail node 350, along with corresponding connection lines, form a branch path. The flow logic corresponding to the branch path is: performing conditional judgment, executing any one of Step 2-1, Step 2-2, and Step 2-3 according to a result of conditional judgment, and ending the processing after execution is completed.

If the user wants to view the entire branch path, the user may trigger a highlighting operation for the parent node 330 or the tail node 350. For example, if the user is viewing the flowchart 30 on a personal computer, the user may move a mouse pointer control to the position of the parent node 330 or the tail node 350 to trigger a highlighting operation.

After the highlighting operation triggered by the user is acquired, all objects included in the branch path may be determined as the first object cluster and highlighted. Specifically, a flowchart as shown in FIG. 3B may be displayed. In the implementation shown in FIG. 3B, the parent node 330, the branch node 341, the branch node 342, the branch node 343, the tail node 350, and the connection lines in the branch path are all displayed in bold to facilitate user to distinguish.

Or if the user wants to view a certain sub-path in the branch path, the user may trigger a highlighting operation for an object in the sub-path. For example, if the user is viewing the flowchart 30 on a personal computer and wants to view a sub-path corresponding to Step 2-3, the user may move the mouse pointer control to the position of the branch node 343, or move the mouse pointer control to the position of a connection line used for connecting the parent node 330 and the branch node 343, or move the mouse pointer control to the position of a connection line used for connecting the branch node 343 and the tail node 350. By moving the position of the mouse pointer control, the user may trigger the highlighting operation.

After the highlighting operation triggered by the user is acquired, the branch node 343, the connection line used for connecting the parent node 330 and the branch node 343, and the connection line used for connecting the branch node 343 and the tail node 350 may be determined as the first object cluster and highlighted. Specifically, the flowchart as shown in FIG. 3C may be displayed. In the implementation shown in FIG. 3C, the parent node 330, the tail node 350, the branch node 343, the connection line used for connecting the parent node 330 and the branch node 343, and the connection line used for connecting the branch node 343 and the tail node 350 are all displayed in bold for the user to distinguish.

Based on the display mode switching method provided by the above-mentioned method embodiment, the embodiments of the present disclosure further provide a display mode switching apparatus. Hereinafter, the display mode switching apparatus will be illustrated in conjunction with the drawings.

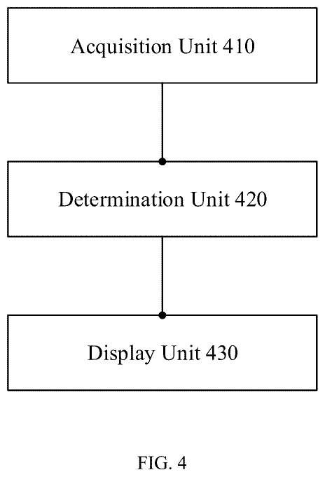

Referring to FIG. 4, the diagram is a schematic structural diagram of a display mode switching apparatus provided by the embodiments of the present disclosure. As shown in FIG. 4, the display mode switching apparatus includes the following units.

An acquisition unit 410, configured to acquire a highlighting operation triggered by a user for a first object, in which the first object belongs to a first flowchart.

A determination unit 420, configured to determine a first object cluster according to the first object, in which the first object cluster includes the first object, and the first object cluster corresponds to a first flow logic in the first flowchart.

A display unit 430, configured to switch a display mode of the first object cluster.

In some optional embodiments, the determination unit 420 is specifically configured to: in response to the first object being a parent node of a first branch path, determine the first flow logic as a flow logic corresponding to the first branch path; and determine nodes and connection lines included in the first branch path as objects in the first object cluster.

In some optional embodiments, the determination unit 420 is specifically configured to: determine a tail node of the first branch path according to the first flow logic; and determine nodes and connection lines between the first object and the tail node as objects in the first object cluster.

In some optional embodiments, the determination unit 420 is specifically configured to: in response to the first object belonging to a sub-path of a second branch path, determine the first flow logic as a flow logic corresponding to the sub-path; and determine nodes and connection lines included in the sub-path as objects in the first object cluster.

In some optional embodiments, the determination unit 420 is specifically configured to: in response to the first object belonging to a loop path, determine the first flow logic as a flow logic corresponding to the loop path; and determine nodes and connection lines included in the loop path as objects in the first object cluster.

In some optional embodiments, the display unit 430 is specifically configured to switch a display brightness of the first object cluster from a first brightness to a second brightness, and the second brightness is greater than the first brightness.

In some optional embodiments, the first object is a node or a connection line in the first flowchart.

Based on the display mode switching method provided by the above-mentioned method embodiment, the present disclosure further provides an electronic device, including: one or more processors; and a storage apparatus, storing one or more programs; the one or more programs, when executed by the one or more processors, cause the one or more processors to implement the display mode switching method according to any one of the above-mentioned embodiments.

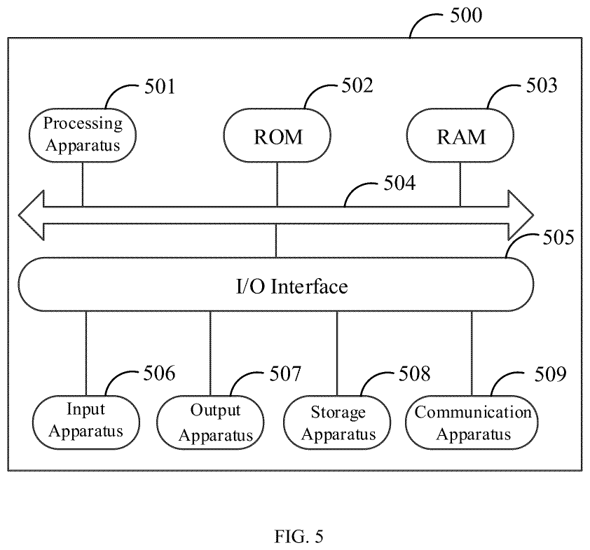

Referring to FIG. 5 below, FIG. 5 illustrates a schematic structural diagram of an electronic device 500 suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus 501 (e.g., a central processing unit, a graphics processing unit, etc.), which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected through a bus 504. An input/output (I/O) interface 505 is also connected to the bus 504.

Usually, the following apparatuses may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of some embodiments of the present disclosure are performed.

The electronic device provided by the embodiments of the present disclosure and the display mode switching method provided by the above-mentioned embodiments belong to the same inventive concept. Technical details that are not described in detail in the present embodiment may be referred to the above-mentioned embodiments, and the present embodiment has the same beneficial effects as the above-mentioned embodiments.

Based on the display mode switching method provided by the above-mentioned method embodiment, the embodiments of the present disclosure further provide a computer-readable medium on which a computer program is stored, and the computer program, when executed by a processor, implements the display mode switching method according to any one of the above-mentioned embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the above-mentioned display mode switching method.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of optional embodiments of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an disclosure specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that the various embodiments in the present disclosure are described in a progressive manner, with each embodiment focusing on the differences from other embodiments, and similar parts between the various embodiments may be referred to each other. For the systems or apparatuses disclosed in the embodiments, because they correspond to the methods disclosed in the embodiments, the description is relatively simple, and the relevant parts may refer to the description of the methods for details.

It should be understood that, in the present disclosure, “at least one (item)” refers to one or more, and “a plurality of” refers to two or more. “And/or” is used to describe the association relationship between associated objects, indicating that there may be three relationships. For example, “A and/or B” may indicate: only A exists, only B exists, and both A and B exist simultaneously, where A, B may be singular or plural. The character “/” generally indicates that the associated objects before and after are in a kind of “or” relationship. “At least one (item)” or similar expressions refer to any combination of these items, including any combination of single (item) or multiple (items). For example, at least one (item) of a, b, or c may indicate: a, b, c, “a and b”, “a and c”, “b and c”, or “a, b, and c”, where a, b, and c may be singular or plural.

It should be noted that in the present disclosure, relational terms such as “first,” “second,” etc. are only used to distinguish one entity or operation from another entity or operation, and do not necessarily require or imply the existence of any actual relationship or order between these entities or operations. Furthermore, the terms “comprise,” “comprising,” “include,” “including,” etc., or any other variant thereof are intended to cover non-exclusive inclusion, such that a process, method, article or device comprising a set of elements includes not only those elements, but also other elements not expressly listed, or other elements not expressly listed for the purpose of such a process, method, article or device, or elements that are inherent to such process, method, article or device. Without further limitation, an element defined by the phrase “includes a . . . ” does not preclude the existence of additional identical elements in the process, method, article or device that includes the element.

The above descriptions of the embodiments of the present disclosure enables those skilled in the art to implement or use the present disclosure. Various modifications to these embodiments will be readily apparent to those skilled in the art, and the generic principles defined herein may be practiced in other embodiments without departing from the spirit or scope of the present disclosure. Therefore, the present disclosure is not to be limited to the embodiments described herein but is to be accorded the widest scope consistent with the principles and novel features disclosed herein.

1. A display mode switching method, comprising:
acquiring a highlighting operation triggered by a user for a first object, wherein the first object belongs to a first flowchart;
determining a first object cluster according to the first object, wherein the first object cluster comprises the first object, and the first object cluster corresponds to a first flow logic in the first flowchart; and
switching a display mode of the first object cluster.

2. The method according to claim 1, wherein the determining the first object cluster according to the first object comprises:
in response to the first object being a parent node of a first branch path, determining the first flow logic as a flow logic corresponding to the first branch path; and
determining nodes and connection lines comprised in the first branch path as objects in the first object cluster.

3. The method according to claim 2, wherein the determining nodes and connection lines comprised in the first branch path as objects in the first object cluster comprises:
determining a tail node of the first branch path according to the first flow logic; and
determining nodes and connection lines between the first object and the tail node as objects in the first object cluster.

4. The method according to claim 1, wherein the determining the first object cluster according to the first object comprises:
in response to the first object belonging to a sub-path of a second branch path, determining the first flow logic as a flow logic corresponding to the sub-path; and
determining nodes and connection lines comprised in the sub-path as objects in the first object cluster.

5. The method according to claim 1, wherein the determining the first object cluster according to the first object comprises:
in response to the first object belonging to a loop path, determining the first flow logic as a flow logic corresponding to the loop path; and
determining nodes and connection lines comprised in the loop path as objects in the first object cluster.

6. The method according to claim 1, wherein the switching the display mode of the first object cluster comprises:
switching a display brightness of the first object cluster from a first brightness to a second brightness, wherein the second brightness is greater than the first brightness.

7. The method according to claim 1, wherein the first object is a node or a connection line in the first flowchart.

8. The method according to claim 2, wherein the first object is a node or a connection line in the first flowchart.

9. The method according to claim 3, wherein the first object is a node or a connection line in the first flowchart.

10. The method according to claim 4, wherein the first object is a node or a connection line in the first flowchart.

11. The method according to claim 5, wherein the first object is a node or a connection line in the first flowchart.

12. The method according to claim 6, wherein the first object is a node or a connection line in the first flowchart.

13. An electronic device, comprising:
one or more processors; and
a storage apparatus, storing one or more programs,
wherein the one or more programs, when executed by the one or more processors, cause the one or more processors to implement a display mode switching method, and the display mode switching method comprises:
acquiring a highlighting operation triggered by a user for a first object, wherein the first object belongs to a first flowchart;
determining a first object cluster according to the first object, wherein the first object cluster comprises the first object, and the first object cluster corresponds to a first flow logic in the first flowchart; and
switching a display mode of the first object cluster.

14. The electronic device according to claim 13, wherein the determining the first object cluster according to the first object comprises:
in response to the first object being a parent node of a first branch path, determining the first flow logic as a flow logic corresponding to the first branch path; and
determining nodes and connection lines comprised in the first branch path as objects in the first object cluster.

15. The electronic device according to claim 14, wherein the determining nodes and connection lines comprised in the first branch path as objects in the first object cluster comprises:
determining a tail node of the first branch path according to the first flow logic; and
determining nodes and connection lines between the first object and the tail node as objects in the first object cluster.

16. The electronic device according to claim 13, wherein the determining the first object cluster according to the first object comprises:
in response to the first object belonging to a sub-path of a second branch path, determining the first flow logic as a flow logic corresponding to the sub-path; and
determining nodes and connection lines comprised in the sub-path as objects in the first object cluster.

17. The electronic device according to claim 13, wherein the determining the first object cluster according to the first object comprises:
in response to the first object belonging to a loop path, determining the first flow logic as a flow logic corresponding to the loop path; and
determining nodes and connection lines comprised in the loop path as objects in the first object cluster.

18. The electronic device according to claim 13, wherein the switching the display mode of the first object cluster comprises:
switching a display brightness of the first object cluster from a first brightness to a second brightness, wherein the second brightness is greater than the first brightness.

19. The electronic device according to claim 13, wherein the first object is a node or a connection line in the first flowchart.

20. A computer-readable medium, storing a computer program, wherein the computer program, when executed by a processor, implements a display mode switching method, and the display mode switching method comprises:
acquiring a highlighting operation triggered by a user for a first object, wherein the first object belongs to a first flowchart;
determining a first object cluster according to the first object, wherein the first object cluster comprises the first object, and the first object cluster corresponds to a first flow logic in the first flowchart; and
switching a display mode of the first object cluster.
